(19) United States
(12) Patent Application Publication
(10) Pub. No.: US 2010/0006633 A1
(43) Pub. Date: Jan. 14, 2010

(54) Carton Fitments

(75) Inventors: Neil Fowell, Surrey (GB); Peter Michael McGeough, Surrey (GB)

Correspondence Address: K&L Gates LLP, STATE STREET FINANCIAL CENTER, One Lincoln Street, BOSTON, MA, 02111-2950, US

(73) Assignee: Bapco Closures Research Ltd., Surrey (GB)

(21) Appl. No.: 12/439,344

(22) PCT Filed: Sep. 19, 2007
(86) PCT No.: PCT/GB2007/050562

§ 371 Date: Feb. 27, 2009

(30) Foreign Application Priority Data
Sep. 20, 2006 (GB) 0618462.6

(51) Int. Cl. B65D 43/00; B31B 1/84

(52) U.S. Cl. 229/125.01; 493/87

(57) ABSTRACT

A carton fitment (2) for use in fresh packaging has a base flange (4) with an upstanding pour spout (6) adapted to be inserted through an opening in a carton such that the base flange seats inside the carton. A ring of induction heat sealing foil (10) is bonded to an exterior surface of the flange so that the fitment can be induction welded to a paperboard carton. The use of such fitments allows a carton erection and filling machine to be manufactured without the need for expensive ultrasonics welding equipment.

### TECHNICAL FIELD

The present invention relates to carton fitments for use in the field of fresh, that is short shelf life, packaging with cartons that contain no conductive barrier layer. This applies to cartons for packing fresh products such as milk or juices, or products that have a shelf life of, for example 30 days and therefore do not warrant the additional cost of an aluminium barrier carton as required for aseptic packaging. These cartons are typically gable top cartons but can take other forms.

This market segment of cartons without conductive layers represents a significant proportion of the more than 10 billion gable top cartons that are sold annually around the world.

### BACKGROUND ART

Normally a carton fitment having a base flange with an interior surface and an exterior surface and an upstanding pour spout protruding from the exterior surface of the flange is seated inside a paperboard carton with the exterior surface of the flange against an interior surface of the carton and is then ultrasonically welded into position.

The possibility of using induction heat sealing to secure a carton fitment to a container either with or without a metal barrier layer has been disclosed in Patent Citation 0001: WO WO 00/06369 A (TETRA LAVAL HOLDINGS & FINANCE, S.A.). Feb. 10, 2000.

(Pokusa). This document describes carton fitments of the type which have a base flange with an interior surface and an exterior surface and an upstanding pour spout protruding from the exterior surface of the flange. It describes such fitments being used with containers in the form of a TETRA BRIK® package where the fitment is applied with the interior surface of the flange applied to the exterior surface of the container (post-applied), as well as carton fitments that are inserted through an aperture in the container so that the exterior surface of the flange mates with the interior surface of the container. In one non-illustrated example of the post-applied embodiment of FIG. 5, Pokusa discloses a fitment with an annular foil on the interior surface of the closure. Although Pokusa mentions cartons without a barrier layer, its primary focus is on the aseptic field.

In the field of short shelf life packaging, annular induction heat seal foils have been disclosed in
Patent Citation 0002: GB 2416535 A (BAPCO CLOSURES RESEARCH LTD). Feb. 1, 2006.and
Patent Citation 0003: GB 2399814 A (PORTOLA PACKAGING LTD). Sep. 29, 2004. for use external to a container.

In the separate technical field of aseptic packaging the applicant has described a carton fitment that can be used to provide a continuous barrier layer. This is disclosed in
Patent Citation 0004: WO WO 2005/054068 A (BAPCO CLOSURES RESEARCH LIMITED). Jun 16, 2005.

### DISCLOSURE OF INVENTION

The present invention teaches a new carton fitment and a method of assembling that carton fitment to a carton which is coated on at least an interior surface with a plastics coating, by means of induction heat sealing instead of ultrasonic welding.

### Technical Problem

Ultrasonic welding requires an ultrasonic generator and sonic head to make contact with the elements being welded together. In the field this process can be unreliable and certainly is expensive as an ultrasonic generator can cost £25k to £30k per generator and there can be more than one in each carton filling machine. The cycle time of such a process is approximately 400 milliseconds.

### Technical Solution

In order to use induction heat sealing as a method of assembly either the carton fitment or the carton itself needs to incorporate a conductive material that can be heated in an induction field. The present invention addresses the problem arising when there is no conductive material in the carton as in the case of paperboard gable top cartons and also cartons using EVOH or other non-conductive barrier layers.

The present invention accordingly provides a carton fitment having a base flange with an interior surface and an exterior surface and an upstanding pour spout protruding from the exterior surface of the flange, and an annular ring of double sided induction heat sealing foil, characterised in that the ring of induction heat sealing foil has an outer diameter less than an outer diameter of the flange and is bonded to an exterior surface of the flange, and in that the fitment is adapted to seat inside a carton with the foiled exterior surface of the flange against an interior surface of the carton.

The invention also provides a method of assembling a carton fitment having a base flange with an upstanding pour spout protruding from an exterior surface of the flange to a carton having a plastics interior coating, comprising the steps of placing a ring of double sided induction heat sealing foil that has an outer diameter less than an outer diameter of the flange on the exterior surface of the flange and inserting the fitment through an opening in the carton, and induction welding the flange to the paperboard carton.

### Advantageous Effects

Induction does not involve moving parts and is therefore more reliable than ultrasonics. The cost of an induction generator is approximately ç3k to ç6k and one generator can be used for multiple heads at the same time. An induction coil can cost as little as ç200. The speed of induction is comparable to ultrasonic welding and can be faster. The use of such fitments allows a carton erection and filling machine to use induction heat sealing instead of ultrasonic welding. Although the cost of the carton fitment plus foil ring is necessarily greater than the prior art fitment, the total application cost is reduced as the filling machine has a lower capital cost and running cost.

In addition existing moulding tools for carton fitments can be used with minor or no modification.

### BRIEF DESCRIPTION OF THE DRAWINGS

In order that the invention may be well understood an embodiment thereof will now be described by way of example only with reference to the company diagrammatic drawings in which:

FIG. 1 is a perspective view of a carton fitment in accordance with the invention;

FIG. 1A is a detail of a section through the base flange in FIG. 1 before a primary weld is made in accordance with an optional embodiment; and

FIG. 2 is a section through the fitment of FIG. 1.

### DESCRIPTION OF A PREFERRED EMBODIMENT

A carton fitment 2 is made up of a base flange 4 with an upstanding pour spout 6, which is closed by an overcap 8.

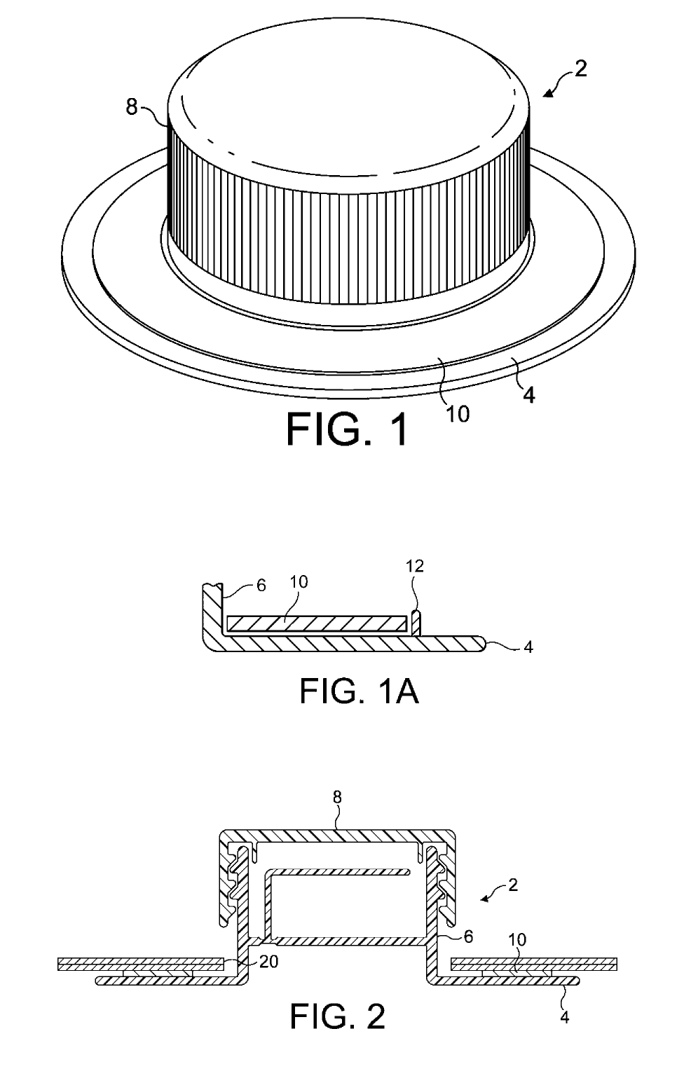

A ring of foil 10 has an outer diameter less than an outer diameter of the flange 4. The foil must be flat and uncreased. The foil 10 is a standard double sided induction heat sealing foil, which has a layer of aluminium coated on each side with a plastics material compatible with the material to which it is to be bonded. For a standard polyethylene- coated paperboard carton and an HDPE fitment, foil with polyethylene coatings on each surface is suitable. Nevertheless, such an annular foil will have exposed aluminium cut edges at its inner and outer diameters. For many products, it is undesirable for them to come into contact with any metal and in this invention, the annular foil is inside the container, whereas it was external in the induction heat sealing solutions proposed for thin-walled extrusion blow moulded bottles as disclosed by Bapco and Portola above. In order to ensure that the cut edge of the aluminium foil is sealed away from the contents, it is necessary for the edge of the foil ring 10 to terminate short of the edge of the flange 4 as shown in FIG. 1.

The foil ring 10 is placed on the exterior surface of the flange 4 that holds the fitment 2 in place inside the carton. The foil ring 10 is placed around the outside of the carton fitment spout on the side of the spout threads. In a preferred embodiment, the foil ring is welded by induction heat sealing to the flange 4 before the pre-foiled fitments are supplied to the packaging line. In this embodiment the foil ring can be seated before the cap is applied. This allows the inner diameter to be chosen so that the ring fits relatively snugly round the spout thus ensuring it is centrally located. The foil must be flat and uncreased in order to ensure that it becomes fused across its entire surface to the flange. During this primary welding process, the cut edges of aluminium could be covered by the fused plastics material of the foil coating and flange. A sacrificial feature 12 as shown in FIG. 1A may be moulded into the flange at the intended location of the outer edge of the ring in order to provide material to cover the edge as described in
Patent Citation 0005: WO WO 2005/054068 A (BAPCO CLOSURES RESEARCH LTD). Jun. 6, 2005.

However, this is not essential since, if there are any parts of the cut edge, which have not been covered during the primary weld, they will become covered during the secondary welding process when the fitment is installed in the carton at the filling plant.

Prior to filling the cartons, a pre-foiled fitment 2 is placed into an opening or hole 20 in a paperboard carton. The paperboard surrounding the hole is squeezed together with the flange 4 in the presence of an electromagnetic field that induces eddy currents in the foil creating heat. This is the normal induction welding process. The plastics material around the hole will completely encapsulate cut edges of the foil ring 10, ensuring that there is no possibility of the contents of the carton after it has been filled coming into contact with the foil. This is because the annular foil ring is now completely sandwiched between the exterior surface of the flange and the interior surface of the carton. Provided the foil is flat and uncreased, it will become fused across both surfaces to the flange and interior surface of the carton respectively. In this way, no passageways are left for fluid to leak from the container around the outside of the fitment.

In an alternative embodiment, standard carton fitments as already used for ultrasonic welding may be supplied to the carton erection and filling machine. The foil rings 10 would then be placed over the spouts just prior to their installation to the hole in the paperboard panel which forms part of a gable top. In this case, the inner diameter of the foil ring must be larger in order to be able to pass over the overcap. The outer diameter will need to be chosen so that even an eccentrically positioned foil ring does not overlap the outer edge of the flange. In this embodiment the foil is sealed on both surfaces simultaneously and the outer cut edge of the aluminium foil within the ring will be completely covered and inaccessible to the contents of the carton once it is fully erected and filled.

The process can be carried out using existing tooling for carton fitments with very little, if any, modification.

A container using such a carton fitment can be assembled to any body which does not contain a conductive barrier layer or indeed to a container which is entirely made of plastics such as PVC, polypropylene, polyethylene or PET. Such a container body can be formed by any process such as injection stretch blow moulding, extrusion blow moulding or thermoforming. In such a case a carton having a plastics interior coating is to be understood as encompassing a wholly plastics body.

1. A carton fitment having a base flange with an interior surface and an exterior surface and an upstanding pour spout protruding from the exterior surface of the flange, which spout is adapted to project externally of a carton to which it is fitted, and an annular ring of double sided induction heat sealing foil, characterised in that the ring of induction heat sealing foil has an outer diameter less than an outer diameter of the flange and is bonded to an exterior surface of the flange, and in that the fitment is adapted to seat inside a carton with the foiled exterior surface of the flange against an interior surface of the carton.

2. A method of assembling a carton fitment having a base flange with an upstanding pour spout protruding from an exterior surface of the flange to a carton having a plastics interior coating, comprising the steps of placing a ring of double sided induction heat sealing foil that has an outer diameter less than an outer diameter of the flange on the exterior surface of the flange and inserting the fitment through an opening in the carton, and induction welding the flange to the carton.

3. A method as claimed in claim 2, wherein the ring is welded to the flange prior to insertion.

4. A container comprising a fitment as claimed in claim 1 assembled to a paperboard carton.

5. A container comprising a fitment as claimed in claim 1 assembled to a body that contains no conductive barrier layer.

6. A container as claimed in claim 5, wherein the body is made of plastics by thermoforming, injection stretch blow moulding or extrusion blow moulding.
